(19) United States
(12) Patent Application Publication
(10) Pub. No.: US 2007/0050516 A1
(43) Pub. Date: Mar. 1, 2007

(54) Method for transmitting electronic data via a dual network in order to increase internet security

(76) Inventor: Csaba Bona, Rheinfelden (CH)

Correspondence Address: BROOKS KUSHMAN P.C., 1000 TOWN CENTER, TWENTY-SECOND FLOOR, SOUTHFIELD, MI, 48075, US

(21) Appl. No.: 10/595,155

(22) PCT Filed: Mar. 2, 2004
(86) PCT No.: PCT/IB04/00612

§ 371 Date: Mar. 8, 2006

(30) Foreign Application Priority Data
Sep. 10, 2003 (CH) 154403

(51) Int. Cl. G06F 15/16

(52) U.S. Cl. 709/232

(57) ABSTRACT

In a method for increasing internet security, the data to be transmitted are prepared in such a way that the useful information bits having an odd bit index are gathered in a packet and the useful information bits having an even bit index are gathered in another packet. The two types of packets are transmitted over two different networks and, after their transmission, are recombined by the receiver according to the original information. The transmission of the prepared data over two different networks makes unauthorised access to the original information difficult during their transfer.

The present invention relates to a method, based on patent claim 1, which drastically reduces the known rates of hacker attacks on computer systems today. There are numerous devices for the security of computer systems, but they do not fulfill their purpose. They require vast amounts of resources, and despite this computer hackers cause 600-800 billion USD (American dollars) of damage annually worldwide.

The central element in communication among computer systems is the packet. The data are split serially into packets. This means that the first X bits are defined as packet 1, the second X bits are defined as packet 2 etc. These packets are then sent from the sender to the receiver in a network (e.g. on the internet). Apart from data, the packets contain addresses and rules regarding how they need to be assembled again at the receiver. Even if partial encryption is used, everything can be found at the same location, at the same time (in the same time window), in one packet and in the same network. For this very reason, the data in such packets in a network are susceptible to unauthorized access. These facts are actually what make it possible for hackers to “tap” lines and read confidential data or penetrate other computer systems. “Lines” are also to be understood to mean wireless communication channels.

All the security devices used (encryption, various algorithms, signature, firewall, virtual networks, Secure Sockets Layer) change nothing about the facts presented above, however, and are therefore also not able to take satisfactory care of the security of the computer systems involved.

It is the object of the invention to eliminate these drawbacks. This object is achieved by the features of patent claim 1.

The physical (geographical) and spectral separation of the data during the time-shifted transmission in two networks give unauthorized access to the actual data next to no chance.

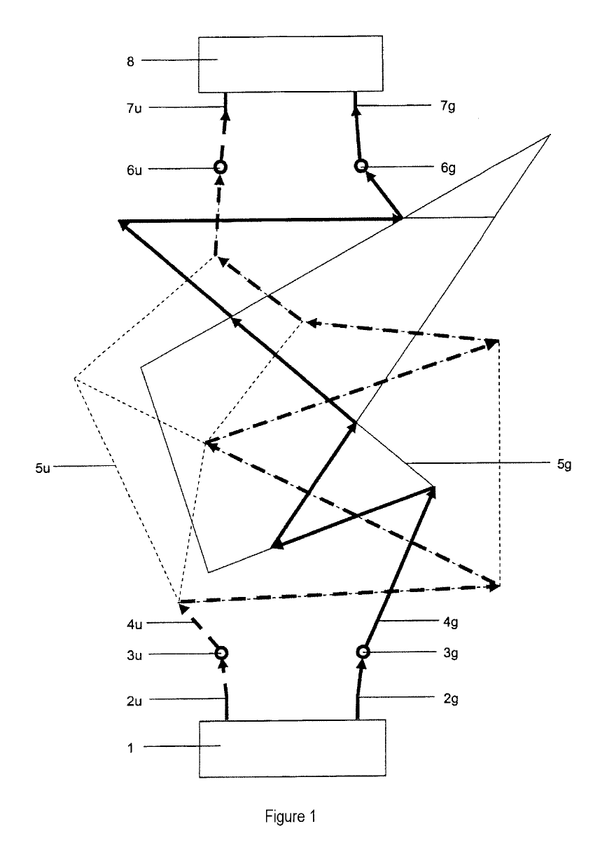

The quintessence of the method is the physical (geographical) and spectral separation of the data and a small time shift in the transmission in two networks (dual network), FIG. 1, so that the separate data are already implicitly encrypted—by a new method of packet preprocessing, table 1.

TABLE 1

| | Bit number | | | | | | | | | | | | Packet |
|---|---|---|---|---|---|---|---|---|---|---|---|---|---|
| | 0 | 1 | 2 | 3 | 4 | 5 | 6 | 7 | 8 | 9 | 10 | N | length* |
| Pack- | 1 | 1 | 0 | 0 | 1 | 0 | 0 | 1 | 1 | 1 | 0 | . . . | 4096 |
| et | | | | | | | | | | | | | |
| today | | | | | | | | | | | | | |
| O | | 1 | | 0 | | 0 | | 1 | | 1 | | . . . | 2048 |
| pack- | | | | | | | | | | | | | |
| et* | | | | | | | | | | | | | |
| E | 1 | | 0 | | 1 | | 0 | | 1 | | 0 | . . . | 2048 |
| pack- | | | | | | | | | | | | | |
| et* | | | | | | | | | | | | | |

*O packet = odd bits, E packet = even bits, N = number, packet lengths are examples

This new method of preprocessing the data into O packets and into E packets produces two, independently useless halves of the information which hackers are no longer able to evaluate. The implicit encryption also results in a saving on bandwidth or an increase in throughput.

The example involves 2048 bits/packet/network (O network and E network), as shown in table 1. This is a long way over the critical length per O packet and per E packet. Today's computers cannot calculate this length for the packets—within a useful period—through combination (“trying out” all options, by means of a computer program.)

Addresses, message identification (message ID) and the packet numbering, which are likewise part of a packet, are not changed by this method.

An exemplary embodiment will be used to explain the invention with reference to a figure (FIG. 1). FIG. 1 shows an embodiment of the inventive dual network, with a sender and with a receiver, and also with the path taken in the O network (dashed lines) by an O packet (dashed arrows) and with the path taken in the E network (solid lines) by an E packet (solid arrows).

A sender 1 sends a message to a receiver 8. The message comprises O packets 4u and E packets 4g.

An O packet 4u in the O network 5u takes the following path:

O port 2u on the sender 1,

O provider 3u for the sender 1,

O network 5u,

O provider 6u for the receiver 8,

O port 7u on the receiver 8.

An E packet 4g in the E network 5g takes the following path:

E port 2g on the sender 1,

E provider 3g for the sender 1,

E network 5g,

E provider 6g for the receiver 8,

E port 7g on the receiver 8.

When the O packets 4u and the E packets 4g have been preprocessed, the data are transmitted from the sender to the receiver. The O packets via the O network 5u, and the E packets via the E network 5g. These are two, clearly separate networks (dual network), without a common node. The networks are produced through quasi-duplication of today's networks, which we are calling O network and E network (O=odd, E=even). Duplication is to be understood to mean duplication of the number of nodes—in today's network. This is merely quasi-duplication, because the number of O nodes and the number of E nodes do not need to be identical. (The number of routers or gateways in the O network and in the E network do not have to be identical.) The nodes in the two networks are at different locations.

The available spectrum (bandwidth) is used dynamically. This dynamic allocation of the channels, the distance between the nodes in the two networks and the dynamic routing produce the physical (geographical) and spectral separation of the C packets and the E packets during transmission.

Each terminal (PC, server) has two identities: O identity and E identity. One connects the terminal to the O network and the other connects it to the E network. The O packets look for their path in the O network, and the E packets look for their path in the E network. This is done without any indication that they belong together and that they will arrive at the same terminal.

Devices which are responsible for forwarding the packets in the respective network (routers and gateways) are respectively connected just to one network (O network or E network) and perform their tasks as though there were just one network. This is normal practice today—before the introduction of the dual network.

After the transmission, the receiver reassembles the O packets and the E packets.

A transmission usually comprises more than just one packet. One component of the packets is an identification of the transmission (message ID). In the dual network there is one for the O network and one for the E network. At the end of the transmission—as the last O packet—the sender sends the E message identification (E message ID) for the transmission in the E network (or vice versa) to the receiver. This allows the (authorized) receiver to reassemble the O packets and the E packets.

In theory, the dual network can be generalized as an N network (N=1, 2, 3, . . . )

The dual network proposed here is suitable for any transmission medium. It is undoubtedly simpler to connect the terminals to the two networks for the wireless communication.

Conventional certification, signature and cryptography can be used in combination with the dual network.

1. A method for transmitting electronic data, characterized in that the sender preprocesses the data into N types of packets by virtue of the packet preprocessing stage combining every N-th (N=1, 2, 3, . . . ) bit into one type from the N types of packets, and the N types of packets are sent to the receiver independently of one another, with spectral separation via N networks at different transmission times and/or with different transfer times.

2. The method as claimed in claim 1, characterized in that the sender preprocesses the data into two types of packets (4u, 4g) which are sent to the receiver independently of one another, via two networks (5u, 5g), at different transmission times and/or with different transfer times.

3. The method as claimed in claim 2, characterized in that the two types of packets (4u, 4g) are sent via two separate computer networks (5u, 5g) which do not contain a common node.

4. The method as claimed in claim 2, characterized in that the bits with even-numbered bit positions in the original bit sequence in the useful information are combined into one type of packet and the bits with even-numbered bit positions are combined into another type of packet.

5. The method as claimed in claim 2, characterized in that each of the terminals, sender and receiver, connected to the two computer networks has two identities associated with the two networks.

6. The method as claimed in claim 5, characterized in that a respective identity for the respective terminal, sender and receiver, connects said terminal to a respective one of the two computer networks.

7. The method as claimed in claim 1, characterized in that devices which are responsible for forwarding the packets in the respective computer network are respectively connected just to one computer network.

8. The method as claimed in claim 2, characterized in that the two types of packets can be assembled by the two message identifications sent in the last packet in accordance with the original information.

9. The method as claimed in claim 2, characterized in that the time shift between the transmissions in the two computer networks is produced by the different paths taken.

10. The method as claimed in claim 1, characterized in that the transmission in N networks takes place over wires and/or wirelessly.
